(19) United States
(12) Patent Application Publication
(10) Pub. No.: US 2026/0187669 A1
(43) Pub. Date: Jul. 2, 2026

(54) AUTOMATED METHOD FOR GENERATING ESTIMATES FROM PHYSICAL SPACES

(71) Applicant: National Services Bureau, LLC, Mukilteo, WA (US)

(72) Inventors: Maksim Y. Nazarchuk, Everett, WA (US); Andrey Y. Nazarchuk, Everett, WA (US); Timofey Y. Nazarchuk, Lynnwood, WA (US)

(21) Appl. No.: 19/008,198

(22) Filed: Jan. 2, 2025

(51) Int. Cl. G06Q 30/0201; G06Q 50/08; G06V 10/40

(52) U.S. Cl. CPC G06Q 30/0206; G06Q 50/08; G06V 10/40

(57) ABSTRACT

A computer-implemented method includes presenting a user interface to a user, upon receiving an input from the user, presenting a beginning user interface to the user, receiving customer information through the user interface, providing directions to the user for gathering information and photos about one or more spaces for a construction project, providing prompts to the user and receiving information including at least a type of construction project, sending the photos and information about the construction project to a fine-tuned large language model (LLM), using the fine-tuned LLM to select relevant elements from the photos and information, and produce one or more data objects, receiving the data objects from the LLM and converting the data objects to one or more construction estimates, the construction estimate including at least a labor estimate, and presenting the construction estimate through the user interface to the user.

### TECHNICAL FIELD

This disclosure relates to generation of estimates for construction and remodeling projects, more particularly to using an artificial intelligence tool to provide estimates to users.

### BACKGROUND

Generating estimates for construction and remodeling projects takes a lot of time and may have many complications. Typically estimates involve many different measurements, determining the steps needed to perform the project such as whether or not it required demolition, the different steps and products needed to perform the project, tracking the different tasks that need to be done, etc. It may be a few days or weeks before the estimate is completed. Being able to produce an almost instant estimate, with few requirements from the user, would make the entire process easier and simpler.

### BRIEF DESCRIPTION OF THE DRAWINGS

FIG. 1 shows a space either to be remodeled or in which construction will be done and an embodiment of a system for generating automated estimates.

FIG. 2 shows an overall flow chart of an embodiment of a method to employ a fine-tuned large language model to provide an estimate of a construction project.

FIG. 3 shows an embodiment of a user interface for an automated Estimator.

FIG. 4 shows an embodiment of a user interface the provides instructions for the user to provide photos and information of the space.

FIG. 5 shows an embodiment of a user interface used to gather information about the construction project.

FIG. 6 shows an embodiment of a user interface with information and photos to be submitted to a fine-tuned large language model.

FIG. 7 shows an embodiment of a construction labor estimate presented to the user.

FIG. 8 shows an embodiment of a product page from a vendor listing different types of materials available from different suppliers.

FIG. 9 shows an embodiment of a construction estimate including labor and materials presented to the user.

FIG. 10 shows an embodiment of a user interface in which the Estimator prompts for specific information based upon the type of construction project.

FIG. 11 shows an embodiment of a user interface in which the Estimator provides one or more prospective images of the space the prompts for the user to give feedback.

FIG. 12 shows an embodiment of a timeline and schedule for a construction project.

FIG. 13 shows an embodiment of a user interface having access to design help.

FIG. 14 shows an embodiment of a user interface providing a notice and links to building codes.

FIG. 15 shows an embodiment of a user interface providing an option for speech-directed assistance.

### DETAILED DESCRIPTION OF THE EMBODIMENTS

The embodiments herein involve a purpose-trained, fine-tuned, large language model (LLM). The LLM, or “model” may reside locally to the estimate provider, in the cloud, or reside in a model service provider's system. The model used herein has undergone training and fine-tuning to allow it to interpret text and images to provide measurements. Depending upon the training of the model, the model may provide other types of information in response to user prompts, as will be discussed in more detail in further discussion below.

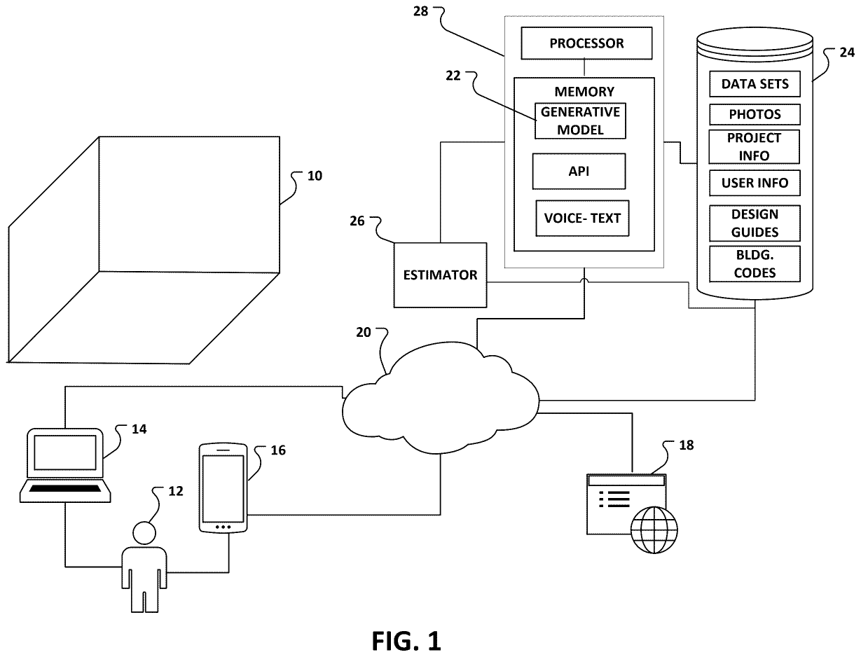

FIG. 1 shows an overview of a system that provides automated estimates to users. The discussion below employs some specific terminology defined here. As used here, the term “user” means the person who actually operates the Estimator 26 to generate estimates. This user may be a homeowner, renter, or a landlord, as examples, or a contractor. This discussion defines homeowners, renters, landlords, etc., as “customers who control the space,” where “space” means the space to be remodeled or in which construction will occur such as 10. The space may involve many different spaces within it, such as rooms, or sections of a room, in a house, or a building, or some exterior part of the structure.

“Contractors” may include construction contractors, interior designers, etc., meaning professionals who are involved in construction projects. A contractor may be the user and may enter the information from the customer into Estimator 26. The user 12 of whatever kind will access the Estimator in one of many ways. The user may access it through their computer 14 by typing in the URL for a website used for the Estimator. The user may launch an application (app) on their mobile devices 16, such as a smart phone or tablet. The user may use the computer or mobile device to access the URL for a vendor's website 18, and the vendor may have a plug-in for the website to allow users to access Estimator 26.

The term “vendor” as used here means any party in this environment that sells products or services. This may include, but is not limited to home improvement supply stores such as Home Depot® or Lowes®; sellers of particular types of materials, such as flooring, plumbing, lighting; installers, electricians, plumbers, painters; and construction contractors, interior designers, consultants, etc. The term “supplier” means the supplier of the materials to be used.

The discussion below uses specific examples of types of construction projects. No limitation to any such type of construction project should be inferred. Many examples are provided for ease of understanding. The construction may be new construction or a remodeling project. The remodeling project may be a surface remodel that only changes the surface with some minor changes to other parts, like flooring, painting, woodwork, etc. It may comprise an infrastructure remodel that involves changes to plumbing, electrical, or other aspects of the remodel of space. It may comprise a structural remodel, where some part of the structure of the space changes, such things as doors, windows, and stairs as examples. These examples merely demonstrate the breadth of the Estimator and its methodology to all types of remodeling or construction projects. The term “construction project” as used here includes all types of construction, including exterior and interior projects, and new construction and remodeling of existing structures and spaces.

Similarly, the discussion below provides examples of many different types of user interfaces. These are provided to demonstrate that the method and system has those capabilities. Again, these are examples and are not intended to be an exhaustive list or set of possible user interfaces and capabilities. User interfaces may differ wildly from those that employ the methods and system described herein.

Prior to the user interaction with the Estimator 26, the generative model 22 to which the Estimator is connected has undergone fine-tuning, or training, using data sets that comprise photographs and descriptions of spaces, with their corresponding measurements and labels of relevant data. The training data will be refined and sorted into specific forms that will allow the LLM to read and ‘understand’ the data in order to provide answers to user inquiries.

This trains the model to provide measurements and estimates based upon inputs from users. The data sets used for training, the photos uploaded by users, project information such as vendors, suppliers, building codes, etc., and user information may also reside in the database 24. Database 24 may also represent multiple databased distributed across the various sites and components of the system.

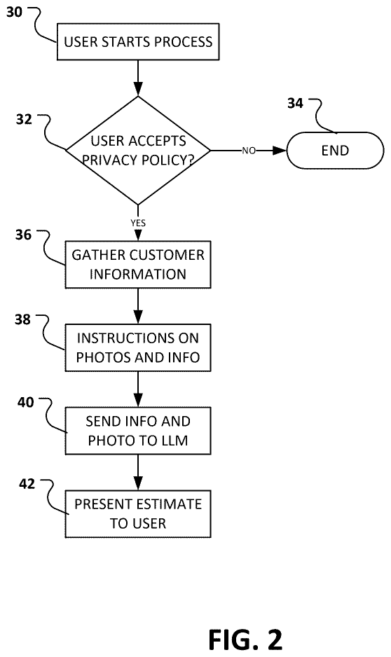

The user accesses the user interface for the Estimator 26 through one of the above examples or by some other method. The actual access will typically occur across one or more networks such as 20. The Estimator 26 may reside on server 28 that has a processor that executes code to operate the model 22, or it may reside elsewhere, such as the provider's proprietary space through which others access the model. The server 28 receives information and pictures of the space that will either be remodeled or in which new construction will occur through its application programming interface (API) and provides the information to the generative model. The generative model will ultimately produce a form of an estimate of one of many types and may interact with the user through various user interfaces. FIG. 2 shows a flowchart of an embodiment of a user interaction with the Estimator.

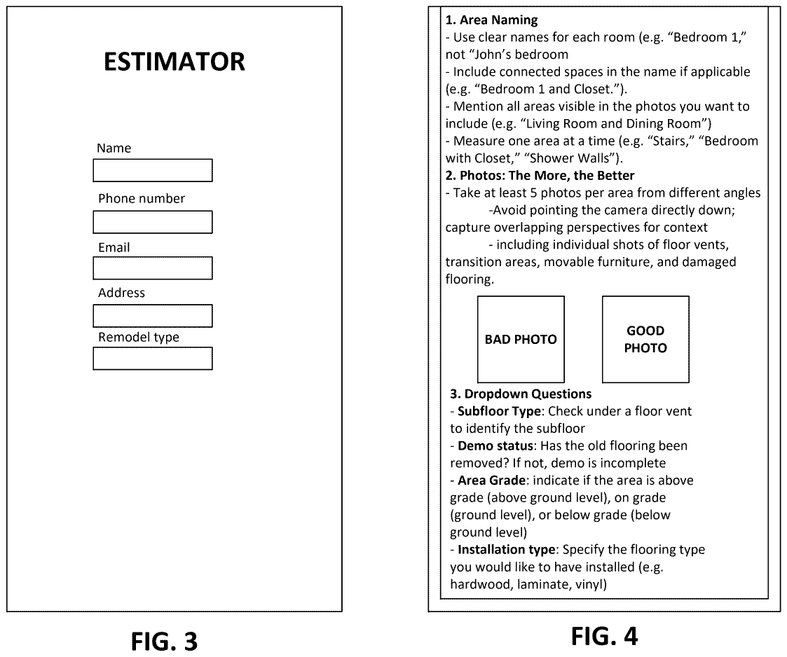

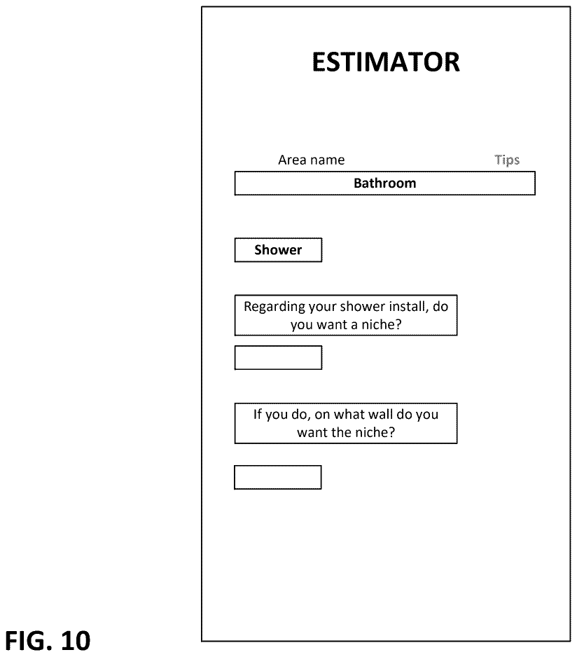

In FIG. 2, the user starts the process. The user may be presented with a privacy policy at 32. If the user accepts the policy at 32, the process continues. If the user rejects the policy, the process ends, and the user will be barred from using the Estimator. If the process continues, Estimator 26 will gather the customer information at 36. FIG. 3 shows an embodiment of a beginning user interface. The user may designate what ‘type” of construction project is being done to allow the system to prompt for more information, as will be discussed regarding FIG. 10. If the user is a contractor, the contractor would have already signed in, so will enter the customer information. As will be seen in the further discussion, the user will have the ability to save the estimate when the user is a contractor.

At 38, the Estimator 26 provides directions to the user on how to provide the information and photos needed by the Estimator to generate the construction estimate. FIG. 4 shows an embodiment of instructions, both for providing the information and for taking the photos. The photos are used to determine measurements of the space, as well as in identifying things such as furniture to be moved, vents needing installation, baseboards, etc.

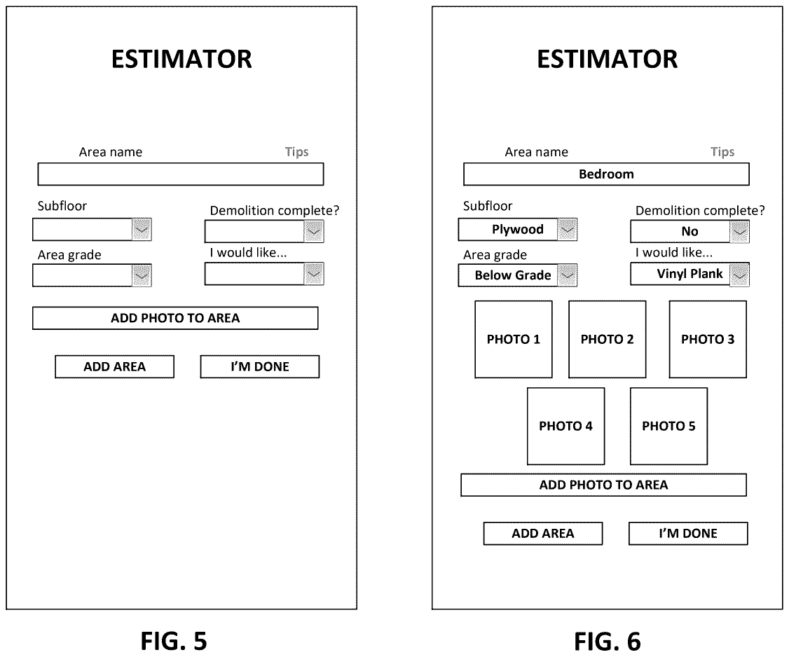

FIG. 5 shows an embodiment of a user interface for a construction project that involves flooring. FIG. 6 shows the embodiment of a user interface that has the information and the photos needed. One should note on FIG. 6 that the user has the ability to add another area to the project, such as a second room for the flooring project used in the example.

Returning to FIG. 2, the photos and information are sent to the Estimator and its LLM in one of many ways. The Estimator could collect both the information and the photos and send them to model 22, or the Estimator could collect one or the other and the model could receive one of them directly. The model takes the information and the photos. It reviews the photos for relevant information, applies the knowledge it obtained from its training, and returns its trained response. In the flooring example, the model would identify the relevant information, such as the walls, furniture that needs to be moved, vents, transitions between rooms, as well as the size of the room. The model then returns object data to the Estimator. In one embodiment, the response comprises JSON (JavaScript Object Notation) code. Estimator 26 translates that to a line-item estimate and presents the estimate to the user at 42.

In one embodiment, the photos are directly uploaded from the user to the database 24 of FIG. 1, the user then answers the questions and requests the estimate. The Estimator 26 provides server 28 with a temporary link to each photo stored in the database 24. In some embodiments, the server and the database may be under control of different entities, such as hosted cloud storage and a subscription server owned by two different providers. The fine-tuned model 22 connected to the Estimator 26 then receives the answers to the user questions/prompts from the Estimator, and the photos. It evaluates the information and photos and provides the result to Estimator 26. The Estimator 26 then translates the result into a line-item estimate that is then presented to the user. The photos may be sent from the user's device to Server 28 using some sort of encoding. In one alternative, the photos may be stored in Estimator 26 and then sent directly to server 28. In either case, the Estimator provides the user the ability to take the photos, so for purposes of this discussion here, the Estimator “sends” the photos to the model.

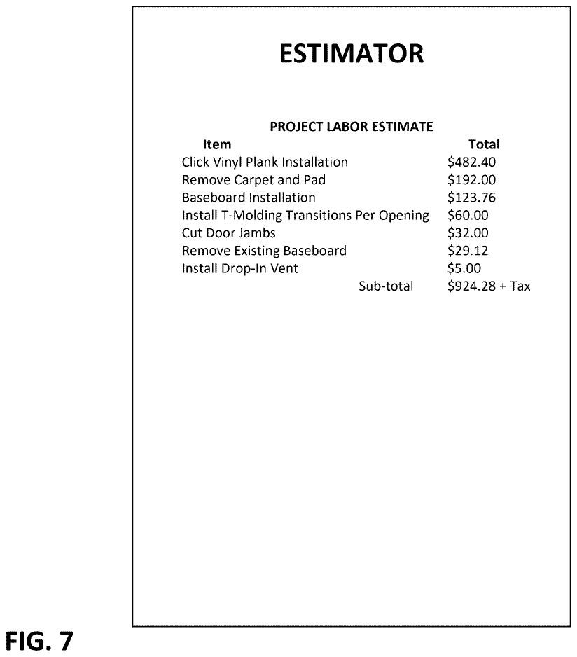

FIG. 7 shows an embodiment of the estimate. In this embodiment, only labor was included, but one can see the various elements of the project, including the removal of the existing carpet and pad, the need for baseboards, t-moldings, and a vent.

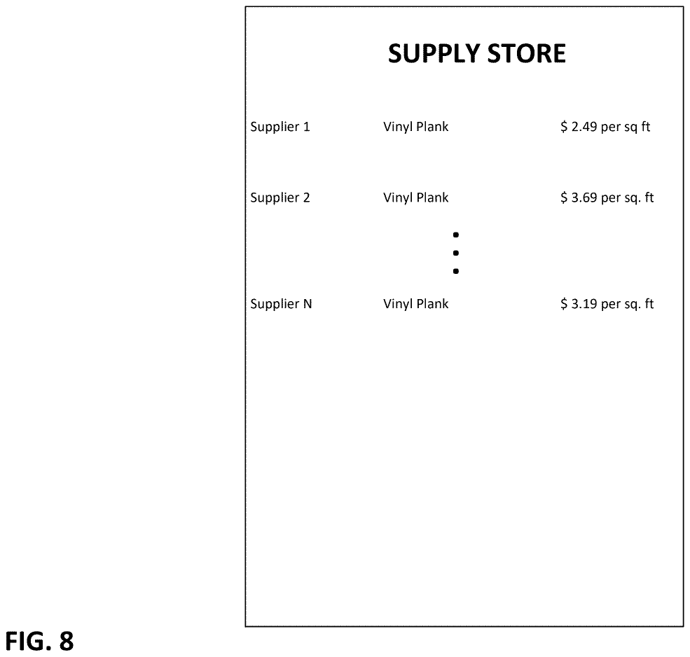

FIG. 8 shows an embodiment of a user interface that the user can access from the user interface of the Estimator if the user also wants to estimate materials. The particular embodiment of FIG. 8 shows an interface to a supply store that may sell many different kinds of materials, such as flooring, fixtures, paint, etc., and accessory materials. For a flooring project, for example, the accessory materials may include the t-moldings, the baseboards, and the vent. For other projects, accessory materials may include any materials outside the main type of material being listed. In another example, the materials may be cabinetry and accessor materials may comprise handles.

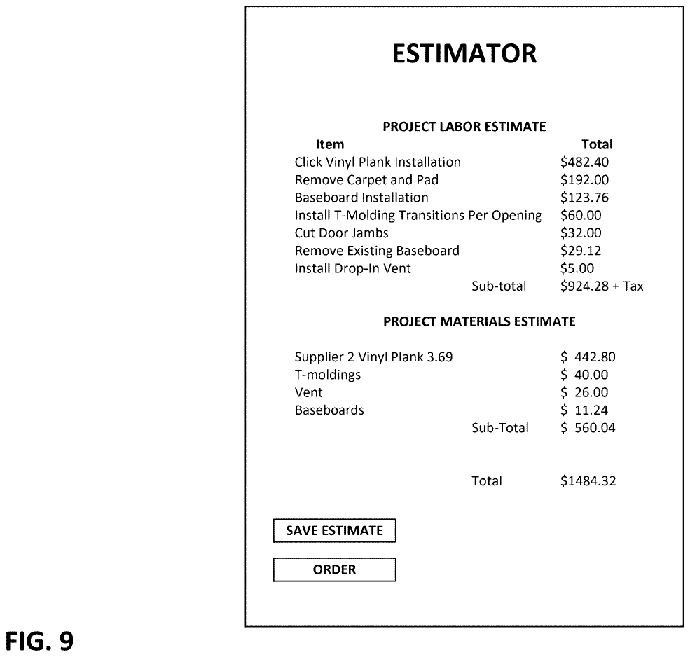

FIG. 9 shows a user interface that includes both the labor estimate and the materials estimate. The materials estimate may be generated by the Estimator based upon the measurements and accessory materials identified by the fine-tuned model or may be generated by the model as well. For contractors, the interface may also provide the contractor with the ability to save the estimate. For example, the contractor may save the estimate and send it to the consumer. If the consumer approved the estimate, the contractor could access the estimate and place the order. Contractors may also have the ability to edit the estimate prior to sending the estimate to the consumer.

In one embodiment, as an example, a contractor could receive payment from the user via a point of sale (POS) system. The Estimator 26 would connect to the POS and when the contractor presses a button on the user interface to collect payment, the Estimator would connect to the contractor's POS. The POS would then handle the generation of the invoice and send it for payment.

This system provides many different variations and modifications. FIGS. 10-15 show different user interfaces that demonstrate some of the capabilities of the system.

While the particular variation may be framed within a particular one of the user interfaces, one should note that the variations of features may be provided on any user interface. These are just examples. For example, the contractor or vendor could send a specific link to the homeowner. The homeowner then uses the link and performs the measurement of their space, the contractor or vendor receives the results from the Estimator.

In FIG. 10, for example, the type of construction project has been identified as a bathroom including a shower. The Estimator then prompts the user about preferences specific to the type of project. In this case, the Estimator may inquire as to whether the user wants a niche, or cubby, in the shower wall. If the answer is “yes” the system also asks in which wall they would like the niche. This merely provides one example as to the type of specifics about which the system may inquire.

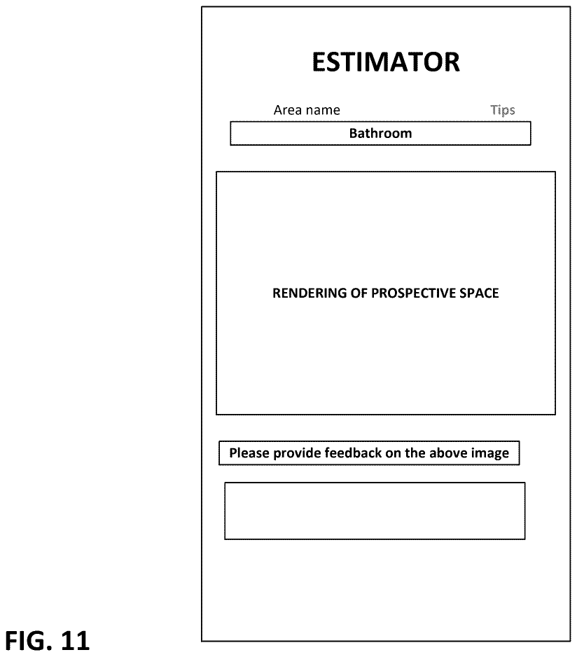

FIG. 11 shows a user interface in which the system renders a prospective image of the space as it would look, whether remodeled or with new construction. in either two or three dimensions. This allows the user to “see” what the space may look like after project completion for the user to make changes prior to generating the estimate.

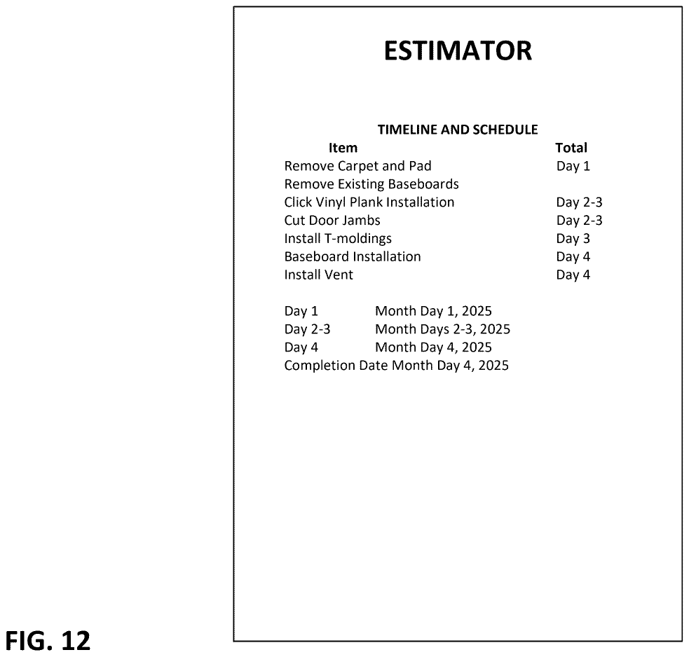

FIG. 12 shows an embodiment of a timeline, in terms of days, for the various parts of the flooring project from FIGS. 5-6. It also provides a schedule by date during which the timeline will be executed. This may be repeated across multiple projects, for the benefit of either contractors or consumers. The Estimator may also provide the ability to build in checkpoints. For example, a particular project may require three checkpoints, one at completion of demolition, one at completion of preparation, and one at completion of installation. The installer/contractor would submit photos of the space at each checkpoint. The LLM would review the photos and extract the relevant information, but in this case the relevant information may be based upon the estimate, purchase order or contract, whatever document is being used to govern the work. The LLM will review the relevant information and the document to ensure that nothing has changed. The LLM may also flag inconsistencies, or note areas in which demo was supposed to occur by the photos show that it had not. Similar reviews will occur after preparation work and after installation. The LLM will compare the completed preparation to the preparation required and will review the final installation and the expected look of the final installation. It will then notify the project manager, the contractor, the consumer, or others to notify that person of any issues.

Another example could involve damage assessments, such as for landlords after a renter moves out, or an insurance adjuster after some incident occurs. The user in this example would take pictures of the damage and send them to the LLM through the Estimator. The LLM would then provide data objects to the Estimator related to the possible causes, repair options, and a range of costs for repair. The Estimator would then convert those objects and provide them to the user in readable form.

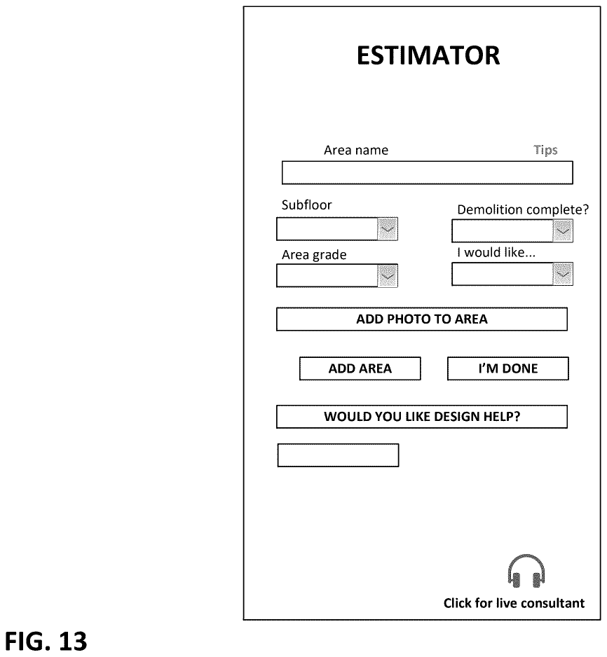

FIG. 13 shows a user interface with an option for asking for design help. This option is shown as part of the original user interface for the flooring project but may be added after the estimate is generator but before it is provided to the user. For example, design help may be offered on the screen in which the image(s) are provided, as well as other places. If the user clicks on the button, or answers yes, the Estimator may provide the user with information about aspects of their project with regard to design. Alternatively, or in addition to the design help, the user may provide a link to allow the user to talk to a live consultant. The system may place a VoIP call to a consultant for design help, use of the system, helping to answer the system questions, etc. Alternatively, the Estimator, upon receiving the request for design help, could open a chatbot window, or provide a voice-text converter for the user to interact with the LLM as an artificial intelligence assistant. The user's camera could also be used to provide views or a video of the space to the LLM through the Estimator.

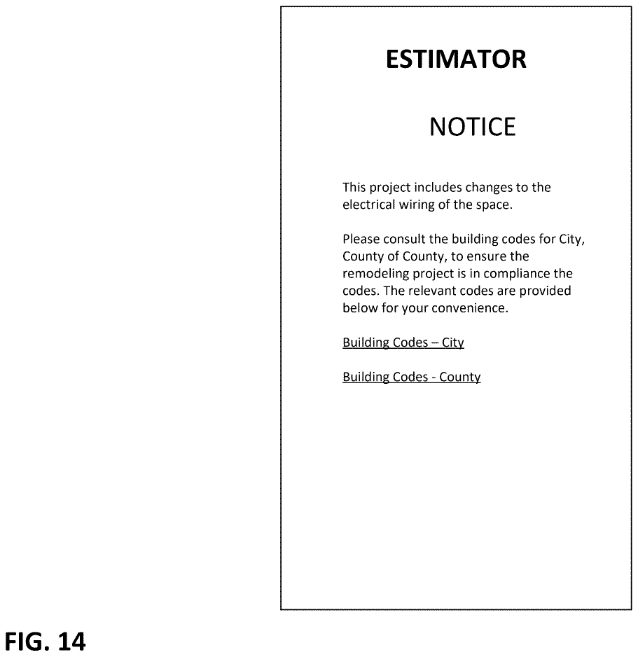

If the project includes aspects that involve building codes, the Estimator and/or the model connected to the Estimator may provide a notice to the user of that fact. In addition, the Estimator may access the city codes or the country codes, or both, based upon the project/customer address. FIG. 14 shows an example of such a notice.

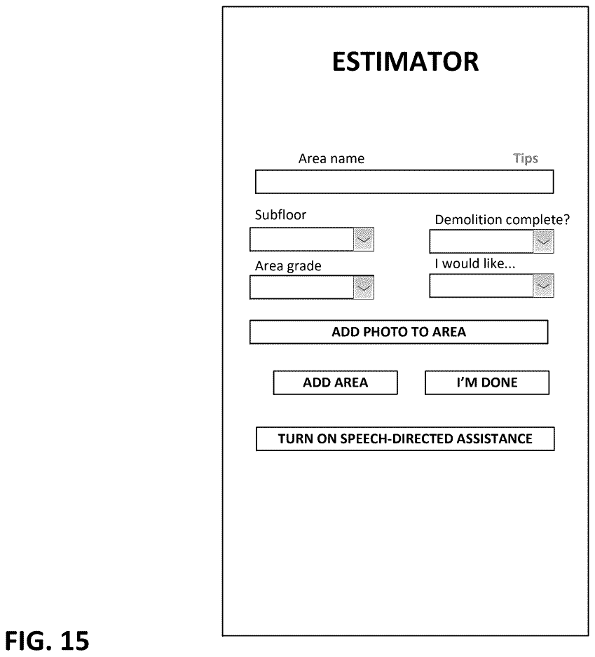

FIG. 15 shows a variation in the instructions shown in FIG. 4 about taking photos. The user may launch a speech-assisted process. During this process the user will fill out basic information and instead of taking photos, by clicking a button, they will open their camera and be able to take a quick video of the room or live scan the room. While in that mode, the user can tell the Estimator that they want to have the current carpet removed and replaced with hardwood. While the user is in this mode, the system will ask them questions as they go through the room and say what they want. Once they are done, they will say something like “I'm done” or “That's all” and the system will confirm that they are done, and the system will give them the pre-measure estimate. In the background the estimate will also have a 3D layout stored. The customer, if they know what kind of flooring they want, would be able to ask for a “layover” and see how that flooring would look in that room. This applies to all types of construction projects, not just flooring, which is an example.

In this manner, an AI-based assistant is provided that can assist users, whether customers or contractors, in generating estimates for remodeling projects. The system provides estimates of labor or labor and materials, or materials, may provide design help, access to lists of materials available, and in general assist the user in developing and managing construction projects.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific aspects of this disclosure have been illustrated and described for purposes of illustration, it will be understood that various modifications may be made without departing from the spirit and scope of the invention. Accordingly, the invention should not be limited except as by the appended claims.

1. A computer-implemented method, comprising:
presenting a user interface to a user;
upon receiving an input from the user, presenting a beginning user interface to the user;
receiving customer information through the user interface;
providing directions to the user for gathering information and photos about one or more spaces for a construction project;
providing prompts to the user and receiving information including at least a type of construction project;
sending the photos and information about the construction project to a fine-tuned large language model (LLM);
using the fine-tuned LLM to select relevant elements from the photos and information, and produce one or more data objects;
receiving the data objects from the LLM and converting the data objects to one or more construction estimates, the construction estimate including at least a labor estimate; and
presenting the construction estimate through the user interface to the user.

2. The computer-implemented method as claimed in claim 1, wherein information about the one or more spaces includes existing materials in the one or more spaces, and whether at least one of demolition and removal is needed.

3. The computer-implemented method as claimed in claim 1, further comprising:
presenting a list of available materials to the user prior to using the fine-tuned LLM and receiving a selection of the desired materials from the user; and
presenting the construction estimate through the user interface to the user includes an estimate of an amount and price of the materials.

4. The computer-implemented method as claimed in claim 3, wherein the user interface resides on a vendor user interface, and the list of available materials comprises available materials available through the vendor.

5. The computer-implemented method as claimed in claim 1, wherein the user is a contractor, and the customer information comprises a customer that controls the space.

6. The computer-implemented method as claimed in claim 5, further comprising providing a list of available materials and vendors and an ordering capability for the contractor.

7. The computer-implemented method as claimed in claim 5, further comprising providing the contractor with the ability to edit the construction estimate prior to sending the estimate to the customer and allowing the contractor to send the estimate to the customer.

8. The computer-implemented method as claimed in claim 1, wherein providing the prompts to the user includes prompts about preferences specific to the type of construction project.

9. The computer-implemented method as claimed in claim 1, wherein the fine-tuned LLM also produces a rendering of one or more prospective images of the space after completion of the construction project, the prospective image being based upon user inputs and photos.

10. The computer-implemented method as claimed in claim 9, further comprising prompting the user for feedback after presenting the image, and adjusting the construction estimate and image in response to the user feedback.

11. The computer-implemented method as claimed in claim 1, wherein the construction estimate includes a timeline and duration for the remodel project.

12. The computer-implemented method as claimed in claim 1, further comprising an interface to enable the user to have a live consultation with one or either a human consultant, or an artificial intelligence assistant.

13. The computer-implemented method as claimed in claim 1, wherein the construction estimate includes a notification that the construction project needs to comply with building codes, and a listing of the relevant building codes.

14. The computer-implemented method as claimed in claim 1, wherein the type of construction project comprises at least one of surface, infrastructure, or structural.

15. The computer-implemented method as claimed in claim 1, wherein providing directions to the user for gathering information comprises live, speech-directed measuring of the space to be remodeled and the photos comprise one of a video or a scan of the space to be remodeled.

16. The computer-implemented method as claimed in claim 1, wherein providing the prompts to the user and receiving responses to the prompts include providing design suggestions and questions in response to the design suggestions.

17. An automated estimator, comprising:
one or more processors configured to execute code to cause the one or more processors to:
provide a user interface to a user;
collect information about a space to be remodeled and user preferences from the user through the user interfaces;
send the information to a fine-tuned large-language model (LLM);
provide photos of the space to be remodeled to the fine-tuned (LLM);
receive data objects from the fine-tuned (LLM), the data object providing relevant information from the photos and information;
translate the data objects from the large-language model into readable format; and
present an estimate for a remodeling project for the space to be remodeled to the user.
